(19) United States
(12) Patent Application Publication
(10) Pub. No.: US 2016/0029196 A1
(43) Pub. Date: Jan. 28, 2016

(54) SYSTEM AND METHOD FOR ROUTING EMERGENCY SERVICES CALLS FROM FIXED WIRELESS TERMINALS

(71) Applicant: West Corporation, Omaha, NE (US)

(72) Inventor: William J. Eich, Wheaton, IL (US)

(21) Appl. No.: 14/805,130

(22) Filed: Jul. 21, 2015

Related U.S. Application Data
(60) Provisional application No. 62/027,673, filed on Jul. 22, 2014.

(51) Int. Cl. H04W 4/22; H04W 4/02; H04W 8/18; H04W 4/16

(52) U.S. Cl. CPC H04W 4/22; H04W 4/16; H04W 4/02; H04W 8/18

(57) ABSTRACT

A method for routing emergency services calls from a subscriber's fixed wireless terminal to a PSAP that serves the location of the subscriber and for delivering traditional landline ALI information associated with the subscriber to the PSAP. The method includes: (a) querying a subscriber database using the subscriber's calling party identifier, wherein the calling party identifier is one or more of an MSISDN, MDN, Calling Party Address or ANI; (b) determining that the subscriber is associated with a fixed wireless terminal; (c) assigning the subscriber's MSISDN as the calling party identifier; (d) assigning Selective Router routing information, wherein the routing information comprises trunk select digits or an ESRN; (e) routing the emergency services call using the assigned Selective Router routing information to the Selective Router and including the MSISDN as the calling party number; and (f) delivering the emergency services call to the PSAP including an ESN assigned to the MSISDN. The method provides routing by “TrunkSelect”+MSISDN and routing by ESRN+MSISDN, in place of the wireless industry-standard “TrunkSelect”+ESRK.

### FIELD OF THE INVENTION

The present invention is directed to telecommunication systems, and especially to effecting routing of emergency services request calls from fixed wireless terminals, such as, by way of example and not by way of limitation, 9-1-1 calls.

### BACKGROUND OF THE INVENTION

A glossary of acronyms and abbreviations associated with emergency services calls is contained in NENA Master Glossary of 9-1-1 Terminology, NENA 00-001, Version 16, dated Aug. 22, 2011 and is incorporated herein by reference in its entirety.

AT&T's Wireless Home Phone (SKU 6165A) is a fixed wireless terminal and provides an alternative to traditional wireline service by working over the AT&T wireless/cellular GSM, 3G/UMTS and 4G/LTE networks. Similarly, Sprint's Phone Connect (SKU PCDH364SPC) is a fixed wireless terminal working over the Sprint wireless/cellular CDMA network and Verizon's Wireless Home Phone (SKU F256VW) is a fixed wireless terminal working over the Verizon wireless/cellular CDMA network. This list is not intended to be exhaustive, but serves to demonstrate the growing market for fixed wireless telephone services.

Fixed wireless telephone services, using fixed wireless terminals such as the ones sold by AT&T, Sprint and Verizon, connect to a subscriber's home wiring so that a subscriber can use his/her existing wired and cordless phone(s). Phone calls originated by a subscriber using a fixed wireless terminal are presented to a network like any other wireless/cellular call. As known by one skilled in the art, emergency service wireless/cellular calls are routed differently from traditional wireline calls, and present very different information to the PSAP (callback number, latitude and longitude, cell address), compared to a wireline call (name, home address, ESN). ESN information is generally not provided to the PSAP for wireless/cellular calls. However, ESN is critical information for the dispatch of first responders.

Currently, wireless/cellular calls route to a PSAP using a “pseudo-ANI” (ESRK) from a pool of numbers (ESRK Pool) assigned to the PSAP. The PSAP does not know the subscriber TN (MDN/MSISDN), only the ESRK is known. The PSAP will then query an ALI with the ESRK. The landline ALI does not contain per-call information for the ESRK, and must forward a query to the carrier's GMLC (for GSM networks), MPC (for CDMA networks) or RDF (for 4G LTE networks). Hereinafter, the term “GMLC” is used to refer to the GMLC, MPC or RDF, depending on the wireless network. The GMLC information is different from what the ALI would normally return for a wireline call, even if the ALI still has the subscriber's original wired TN ALI information.

If a subscriber retains his/her home phone number and wired phone(s), and changes the access from wireline to wireless/cellular, then makes an emergency call, the PSAP will see different information than they would prior to the change to wireless/cellular access. From the subscriber and PSAP point of view, the access method should not affect the information that is delivered to the PSAP.

For emergency services request calls originated from fixed wireless terminals, it would be useful to have a method and system for routing calls so that the same information is presented to the PSAP regardless of the access method (wireline or wireless/cellular).

### SUMMARY OF THE INVENTION

In accordance with one aspect of this invention, disclosed is a method for routing emergency services calls from a subscriber's fixed wireless terminal to a PSAP that serves the location of the subscriber and for delivering traditional landline ALI information associated with the subscriber to the PSAP. The method includes: (a) querying a subscriber database using the subscriber's calling party identifier, wherein the calling party identifier is one or more of an MSISDN, MDN, Calling Party Address or ANI; (b) determining that the subscriber is associated with a fixed wireless terminal; (c) assigning the subscriber's MSISDN as the calling party identifier; (d) assigning Selective Router routing information, wherein the routing information comprises trunk select digits or an ESRN; (e) routing the emergency services call using the assigned Selective Router routing information to the Selective Router and including the MSISDN as the calling party number; and (f) delivering the emergency services call to the PSAP including an ESN assigned to the MSISDN.

In accordance with another aspect of this invention, disclosed is a system for routing emergency services calls from a subscriber's fixed wireless terminal to a PSAP that serves the location of the subscriber and for delivering traditional landline ALI information associated with the subscriber to the PSAP. The system includes: (a) data processing apparatus coupled with a GMLC. The processor in the GMLC performs operations including: (1) querying a subscriber database using the subscriber's calling party identifier, wherein the calling party identifier is one or more of an MSISDN, MDN, Calling Party Address or ANI; (2) determining that the call is associated with a fixed wireless terminal based on a response from the subscriber database query; (3) assigning the subscriber's MSISDN as the calling party identifier; and (4) assigning Selective Router routing information, wherein the routing information comprises trunk select digits or an ESRN. The system further includes: (c) a switch for routing the emergency services call to the Selective Router based on the routing information provided by the GMLC with the MSISDN as the calling party; and (d) a Selective Router for delivering the emergency services call to the PSAP with an ESN assigned to the MSISDN.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

The accompanying drawings, which are incorporated into and form a part of the specification, illustrate a preferred embodiment of the present invention and, together with the description, serve to explain the principles of the invention. In the drawings:

FIG. 1 is a schematic diagram illustrating the wireless/cellular reference architecture and provides context for the present invention;

FIG. 2 is a schematic diagram illustrating the system of the present invention;

FIG. 3 is a flowchart illustrating the method of the present invention; and

FIG. 4 is a block diagram of an example processor for effecting the present invention.

### DETAILED DESCRIPTION

The architecture and call flow for wireless/cellular 9-1-1 service is defined in J-STD-036-A, Enhanced Wireless 9-1-1 Phase 2, dated June 2002 and is incorporated herein by reference in its entirety.

For purposes of illustration, by way of example and not by way of limitation, the present invention will be discussed in the context of an emergency service network in the United States, commonly referred to as a 9-1-1 network. The teachings of the present invention are equally applicable, useful and novel in other special number calling systems, such as maintenance service networks, college campus security networks and other networks.

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

When the terms “coupled” and “connected”, along with their derivatives, are used herein, it should be understood that these terms are not intended as synonyms for each other. Rather, in particular embodiments, “connected” is used to indicate that two or more elements are in direct physical or electrical contact with each other. “Coupled” is used to indicated that two or more elements are in either direct or indirect (with other intervening elements between them) physical or electrical contact with each other, or that the two or more elements co-operate or interact with each other (e.g., as in a cause-and-effect relationship).

In the present invention, when a GMLC receives a routing request for an emergency call, the GMLC queries a subscriber database using the caller's MSISDN. The subscriber database is a novel aspect of this invention and is used to determine if the routing request should be processed as a wireless/cellular call or processed as a call associated with a fixed wireless terminal. In the preferred embodiment, the subscriber database responds to the query with a class of service indicator with one value for wireline and a second value for wireless. In an alternative embodiment, the subscriber database response provides multiple values, where one value indicates wireline and a second value indicates wireless. In another alternative embodiment, the database only sends a response when the caller's MSISDN is associated with a fixed wireless subscriber.

When processed as a wireless/cellular call, the information delivered to the PSAP includes callback number, latitude and longitude and cell address. When processed as a call associated with a fixed wireless terminal, traditional landline ALI information is delivered to the PSAP and includes name, home address and ESN.

In the preferred embodiment, the subscriber database contains a list of fixed wireless subscribers. In an alternative embodiment, the subscriber database is coupled to an ALI and the ALI contains a list of fixed wireless subscribers. When the GMLC identifies a call as being associated with a fixed wireless terminal, the target PSAP is determined using existing procedures (XY to PSAP mapping, Cell Sector to PSAP mapping, pre-provisioned PSAP, etc.). However, instead of assigning a per-PSAP based ESRK to the call, the MSISDN is assigned as the routing digits. Using the MSISDN as the routing digits instead of the ESRK is another novel aspect of this invention.

For routing the call from the wireless MSC to the proper Selective Router/PSAP, the GMLC assigns “Trunk Select” digits which may also be called “steering digits” by one skilled in the art. “Trunk Select” digits are used by the MSC for routing the call to the proper Selective Router. In an alternative embodiment, the GMLC assigns an ESRN instead of “Trunk Select” digits.

A novel aspect of the present invention is the subscriber database detecting whether the MSISDN was previously a traditional wired TN or was a wireless TN based upon the existence of an ALI record in the ALI. If the MSISDN was previously a traditional wired TN, an ALI record for the MSISDN would have been provisioned via the traditional landline infrastructure, meaning that an ANI-ESN record exists in the Selective Router and an ALI record exists in the ALI. If the MSISDN was a wireless TN, an ALI record would not exist in the ALI. To detect whether the MSISDN was previously a traditional wired TN or was a wireless TN, the subscriber database queries ALI for the MSISDN. A novel aspect of the present invention is the subscriber database submitting an add record request to ALI on behalf of the wireless carrier when no ALI record exists.

A meaningful benefit of this invention is that only GMLC enhancements and addition of a subscriber database are required. There is no impact to the Selective Router, ALI or PSAP infrastructure.

Using this method, the PSAP receives the MSISDN and queries ALI with the MSISDN as is done currently for traditional wireline calls. The ALI returns the ALI information with ESN data directly to the PSAP in a manner that is identical to traditional wireline calls. An additional benefit of using this method compared to the present wireless/cellular method is that the ALI information is provided to the PSAP with less delay since a GMLC query is not needed by the ALI.

For one familiar with 9-1-1 routing nomenclature, the present invention may be thought of as routing a wireless/cellular call by “TrunkSelect”+MSISDN (preferred embodiment) or ESRN+MSISDN (alternative preferred embodiment) in place of the wireless industry-standard “TrunkSelect”+ESRK. Heretofore, the “TrunkSelect”+MSISDN and ESRN+MSISDN routing methods never existed and are a novel aspect of this invention. The primary benefit for these novel routing methods is to enable delivery of traditional landline ALI information to the PSAP (including name, home address and ESN).

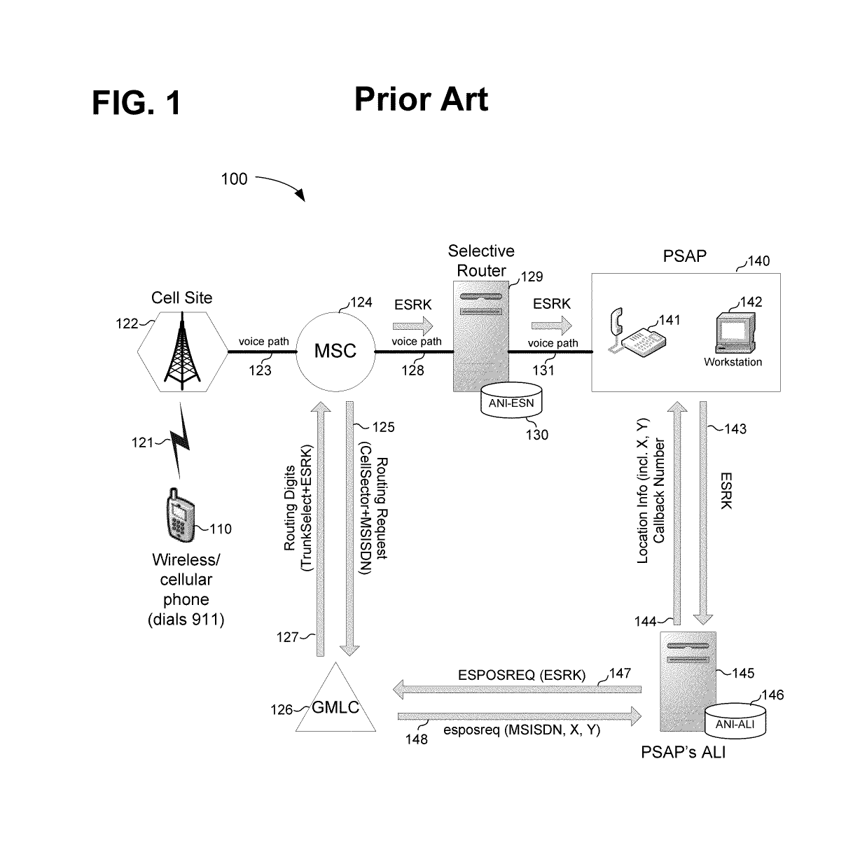

FIG. 1 is a schematic diagram illustrating the wireless/cellular reference architecture 100 for routing of 9-1-1 calls. Callers on a wireless/cellular phone 110 dial 9-1-1 and are connected to cell site 122 over wireless interface 121. A voice path 123 is established between phone 110 and MSC 124. The MSC detects the call is an emergency call and sends a routing request 125 containing the cell site ID, cell sector and the calling party's MSISDN to GMLC 126.

GMLC 126 uses existing procedures (XY to PSAP mapping, Cell Sector to PSAP mapping, pre-provisioned PSAP, etc.) to identify the target PSAP and assigns an ESRK with Trunk Select digits. If Trunk Select digits are not needed for routing the call to a Selective Router, the GMLC assigns an ESRK, without Trunk Select digits. Response 127 to routing request 125 is sent to MSC 124. Based on the routing digits received in response 127 from GMLC 126, MSC 124 determines the appropriate trunk and routes the call over voice path 128 with the ESRK to Selective Router 129. Selective Router 129 is coupled to ANI-ESN table 130. Selective Router 129 uses the ESRK to search ANI-ESN table 130, and uses the resulting ESN to identify and route the call over voice path 131 with the ESRK to PSAP 140. In most cases, this ESN is a general PSAP-wide ESN that does not correspond to any specific Police, Fire, or EMS services.

PSAP 140 receives the call with ESRK and sends query 143 to ALI 145 for information. ALI 145 is coupled to ANI-ALI table 146. ANI-ALI table 146 contains the existing wireline provisioned data for the MSISDN. However, the MSISDN data is not used because PSAP 140 queries ALI 145 with ESRK, not MSISDN. Instead of returning ALI information for the MSISDN as would be done for a traditional wireline call, ALI 145 uses the ESRK to identify a serving GMLC. After ALI 145 determines serving GMLC 126, ALI 145 sends query 147 to GMLC 126 for the wireless call data. GMLC 126 returns wireless call information in response 148. The response 148 from GMLC 126 includes the subscriber MSISDN, and Phase 1 or Phase 2 location (X,Y), with wireless Class of Service. ALI 145 returns the wireless call information to PSAP 140 where it is displayed on workstation 142 with a voice path established between the caller on wireless/cellular phone 110 and PSAP phone 141.

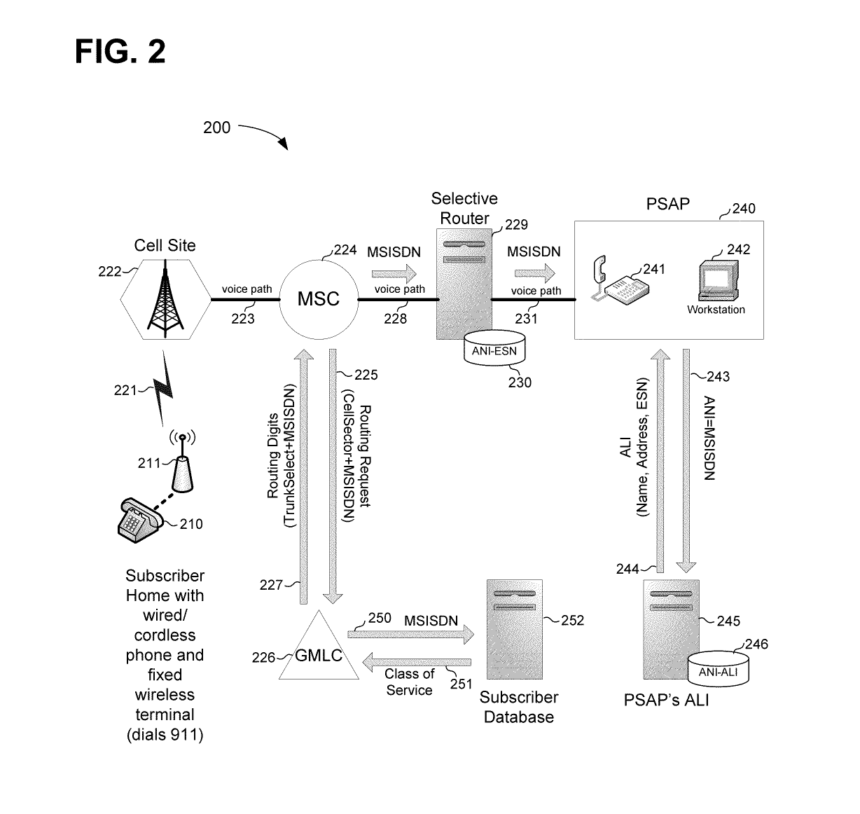

FIG. 2 illustrates an exemplary system 200 of the present invention and introduces a new element: Subscriber Database 252 coupled to GMLC 226. The Subscriber Database contains a list of all fixed wireless subscribers that are assigned to GMLC 226 call handling area. In an alternative embodiment, the subscriber database is coupled to an ALI and the ALI contains a list of fixed wireless subscribers

In the same manner as shown in FIG. 1, wireless/cellular reference architecture 100, a caller dials 9-1-1 from his/her wired/cordless phone 210 that is coupled to fixed wireless terminal 211 and is connected to cell site 222 over wireless interface 221. A voice path 223 is established between phone 210 and MSC 224. The MSC detects the call is an emergency call and sends a routing request 225 containing the cell site ID, cell sector and the calling party's MSISDN to GMLC 226.

Unlike the wireless/cellular reference architecture 100 as shown in FIG. 1, GMLC 226 sends query 250 to Subscriber Database 252 to determine the “Class of Service” for the MSISDN (i.e., is the caller associated with a fixed wireless terminal). In alternative embodiments, Subscriber Database 252 may include or involve querying ALI 245. The “Class of Service” response 251 is sent from Subscriber Database 252 to GMLC 226.

In the same manner as shown in FIG. 1, wireless/cellular reference architecture 100, GMLC 226 uses existing procedures (XY to PSAP mapping, Cell Sector to PSAP mapping, pre-provisioned PSAP, etc.) to identify the target PSAP. Unlike the wireless/cellular reference architecture 100 as shown in FIG. 1, for a fixed wireless caller, GMLC 226 does not assign an ESRK, but sends response 227 with the MSISDN plus TrunkSelect digits as the routing digits to MSC 224. In an alternative embodiment, GMLC 226 sends response 227 with an ESRN instead of Trunk Select digits.

Based on the routing digits received in response 227 from GMLC 226, MSC 224 determines the appropriate trunk and routes the call over voice path 228 with the MSISDN (instead of the ESRK as shown in FIG. 1 wireless/cellular reference architecture 100) to Selective Router 229. Selective Router 229 is coupled to ANI-ESN table 230. Selective Router 229 uses the MSISDN to search ANI-ESN table 230, and uses the resulting ESN to identify and route the call over voice path 231 with the MSISDN to PSAP 240. Because the search on ANI-ESN table 230 was made using the MSISDN instead of the ESRK, the resulting ESN is specific to the MSISDN home address and identifies specific Police, Fire, and EMS services.

PSAP 240 receives the call with MSISDN and sends query 243 to ALI 245 for ALI information. ALI 245 is coupled to ANI-ALI table 246. Unlike the wireless/cellular reference architecture 100 as shown in FIG. 1 where the ESRK is used to query ALI 145, the MSISDN is used and as a result, ALI 245 is able to retrieve ALI information (Name, Address, ESN) from ANI-ALI table 246. ALI 245 returns the ALI information along with a “wireline” class of service to PSAP 240 where it is displayed on workstation 242 with a voice path established between the caller on wired/cordless phone 210 and PSAP phone 241.

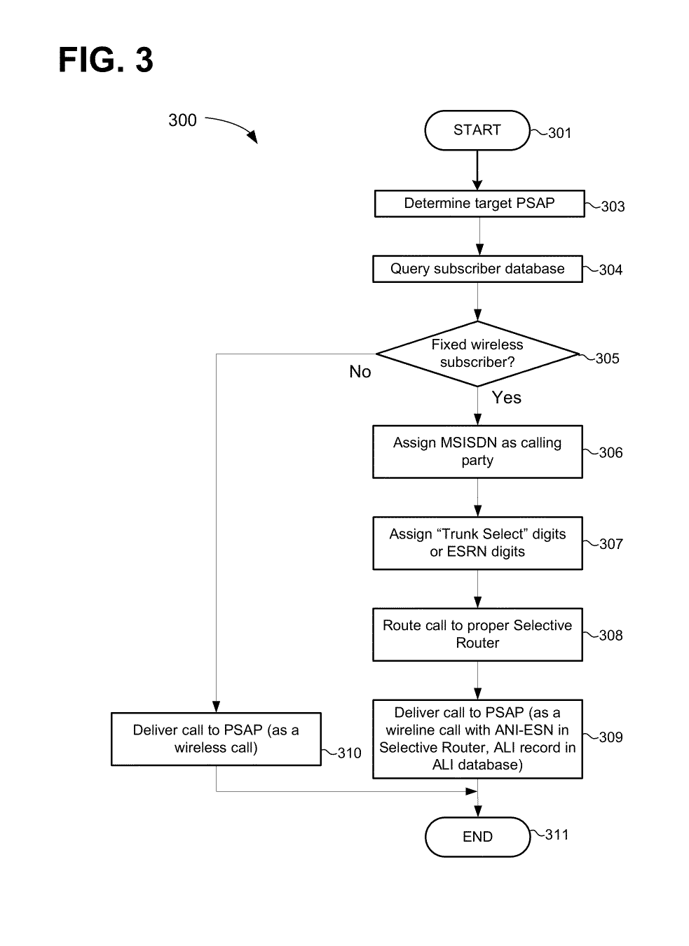

FIG. 3 illustrates an exemplary method 300 for effecting the present invention. Flowchart 300 shows the steps for receiving and processing an emergency services call and starts at step 301. At step 303, the GMLC determines the target PSAP using existing procedures such as XY to PSAP mapping, Cell Sector to PSAP mapping and pre-provisioned PSAP. The procedures for determining the target PSAP are known by one skilled in the art and are not novel to this invention.

Processing continues to step 304, with a novel aspect of the present invention: the GMLC queries a subscriber database. In the preferred embodiment, the subscriber database contains records that require an exact MSISDN match. In an alternative embodiment, the subscriber database may contain a range of MSISDN's by specifying start/end MSISDN numbers or a MSISDN pattern. Processing continues to step 305, where the GMLC determines if the MSISDN is associated with a fixed wireless terminal based on the response from the subscriber database query in step 304. If the subscriber is not associated with a fixed wireless terminal, the method proceeds to step 310, where the call is delivered to the target PSAP (as determined in step 303) as a normal wireless/cellular call and the method ends at step 311.

If the subscriber is associated with a fixed wireless terminal as determined in step 305, processing continues to step 306 where the GMLC assigns the MSISDN as the calling party. This processing step is a novel aspect of the invention. Heretofore, the GMLC would assign an ESRK as the calling party. Based on the target PSAP determined in step 303, at step 307 the GMLC either assigns “Trunk Select” digits or ESRN digits based on configuration data so that the call may be routed to the proper Selective Router in step 308. In the preferred embodiment, the configuration data is based on pre-provisioned data associated with the MSC. In alternative embodiments, the configuration data is based on pre-provisioned data associated with the cell site or applies system-wide. At step 309, the wireless/cellular call is delivered by the Selective Router to the PSAP in the same manner as a call originated from a traditional wireline phone, with the same wireline information presented to the PSAP. After the call is delivered to the PSAP, the method ends at step 311.

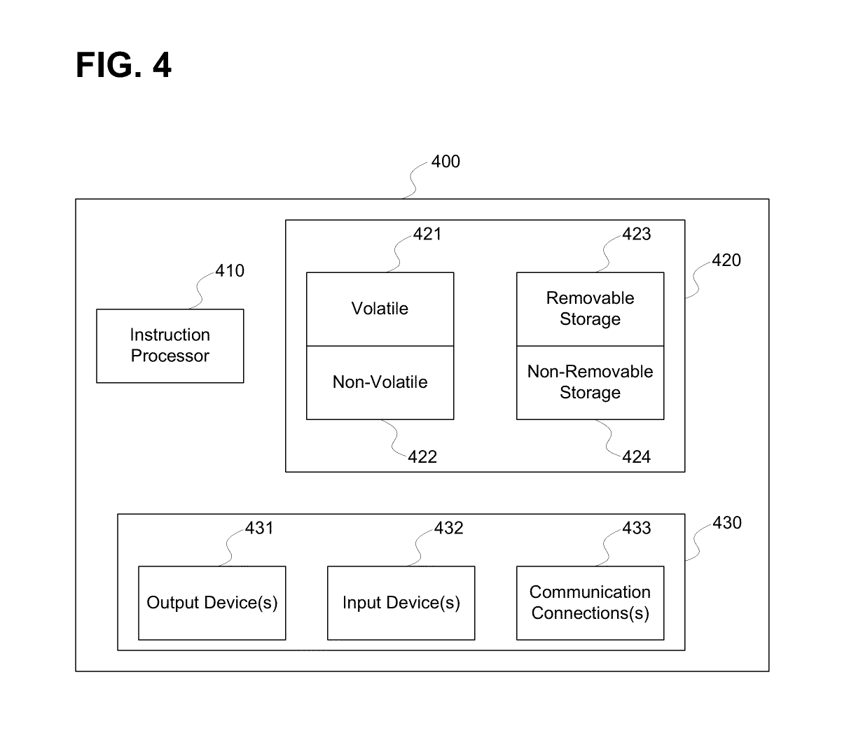

FIG. 4 is a block diagram of an example processor 400 in accordance with this embodiment of this invention. It is emphasized that the block diagram depicted in FIG. 4 is exemplary and not intended to imply a specific implementation. Thus, the processor 400 can be implemented in a single processor or multiple processors. Multiple processors can be distributed or centrally located. Multiple processors can communicate wirelessly, via hard wire, or any combination thereof.

Processor 400 comprises an instruction processor 410, a memory 420, and an input/output 430. The instruction processor unit 410, memory 420, and input/output 430 are coupled together (coupling not shown in FIG. 4) to allow communication among them. The input/output 430 is capable of providing and/or receiving components, commands, and/or instructions, utilized to, for example, receive emergency services call routing requests and route calls.

The processor 400 is preferably implemented as a client processor and/or a server processor. In this exemplary basic configuration, the processor 400 includes at least one instruction processor 410 and memory 420. The memory 420 stores any information utilized in conjunction with transmitting, receiving, and/or processing recipient requests, alert messages, telephonic communications, data communications, etc. For example, as described above, the memory is capable of storing processing instructions for querying databases and assigning address information. Depending upon the configuration and type of processor, the memory 420 can be volatile (such as RAM) 421, non-volatile (such as ROM, flash memory, etc.) 422, or a combination thereof. The processor 400 can have additional features/functionality. For example, the processor 400 can include additional storage (removable storage 423 and/or non-removable storage 424) including, but not limited to, magnetic or optical disks, tape, flash, smart cards or a combination thereof. Computer storage media, such as memory and storage elements 420, 421, 422, 423, and 424, include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processor 400. Any such computer storage media may be part of the processor 400.

The processor 400 includes the communications connection(s) 433 that allow the processor 400 to communicate with other devices, for example the GMLC processor communicates with MSCs and ALI systems as illustrated in FIG. 1. Communications connection(s) 433 is an example of communication media. Communication media typically embody computer-readable instructions, data structures, program modules or other data in a modulated data signal such as a carrier wave or other transport mechanism and includes any information delivery media. For purposes of this patent specification, the term “modulated data signal” means a signal that has one or more of its characteristics set or changed in such a manner as to encode information in the signal. By way of example, and not limitation, communication media includes wired media such as a wired network or direct-wired connection as might be used with a land line telephone, and wireless media such as acoustic, RF, infrared, cellular, and other wireless media. The term computer-readable media as used herein includes both storage media and communication media. The processor 400 also can have input device(s) 432 such as keyboard, keypad, mouse, pen, voice input device, touch input device, etc. Output device(s) 431 such as a display, speakers, printer, etc. also can be included.

It is to be understood that, while the detailed drawings and specific examples given describe embodiments of the invention, they are for the purpose of illustration only, that the system and method of the invention are not limited to the precise details and conditions disclosed and that various changes may be made therein without departing from the spirit of the invention which is defined by the following claims:

1. A method for routing emergency services calls from a subscriber's fixed wireless terminal to a PSAP that serves the location of the subscriber and for delivering traditional landline ALI information associated with the subscriber to the PSAP; the method comprising:
(a) querying a subscriber database using the subscriber's calling party identifier, wherein the calling party identifier comprises at least one member of the group consisting of: MSISDN, MDN, Calling Party Address and ANI;
(b) determining that the call is associated with a fixed wireless terminal;
(c) assigning the subscriber's MSISDN as the calling party identifier;
(d) assigning Selective Router routing information, wherein the routing information comprises at least one member of the group consisting of: trunk select digits and ESRN;
(e) routing the emergency services call to the Selective Router based on the routing information including the MSISDN as the calling party; and
(f) delivering the emergency services call to the PSAP including an ESN assigned to the MSISDN.

2. The method of claim 1, wherein the fixed wireless terminal radio technology comprises at least one member of the group consisting of: GSM, 3G/UMTS; 4G/LTE and CDMA.

3. The method of claim 1, wherein the subscriber database query responds with a class of service indicator, with one indicator value for wireline and a second indicator value for wireless.

4. The method of claim 1, wherein the subscriber database query responds with at least two values, with at least one value for wireline and at least one different value for wireless.

5. The method of claim 1, wherein the subscriber database is coupled to an ALI and the ALI contains a list of fixed wireless subscribers.

6. The method of claim 1, wherein the subscriber database identifies a fixed wireless subscriber as within a range of MSISDNs, with the MSISDN range specified by a start number and an end number.

7. The method of claim 1, wherein the subscriber database identifies a fixed wireless subscriber using an MSISDN pattern.

8. The method of claim 1, wherein the Selective Router routing information is pre-configured based on data associated with an MSC.

9. The method of claim 1, wherein the Selective Router routing information is pre-configured based on data associated with the cell site.

10. A method for adding an ALI record associated with a subscriber's fixed wireless terminal and for routing emergency services calls from the fixed wireless terminal to a PSAP that serves the location of the subscriber and for delivering traditional landline ALI information associated with the subscriber to the PSAP; the method comprising:
(a) querying a subscriber database using the subscriber's calling party identifier, wherein the calling party identifier comprises at least one member of the group consisting of: MSISDN, MDN, Calling Party Address and ANI;
(b) determining that the call is associated with a fixed wireless terminal;
(c) querying an ALI database using the subscriber's MSISDN;
(d) determining that an ALI record does not exist for the MSISDN;
(e) submitting an add record request to ALI on behalf of the wireless carrier when no ALI record exists;
(f) assigning the subscriber's MSISDN as the calling party identifier;
(g) assigning Selective Router routing information, wherein the routing information comprises at least one member of the group consisting of: trunk select digits and ESRN;
(h) routing the emergency services call to the Selective Router based on the routing information including the MSISDN as the calling party; and
(i) delivering the emergency services call to the PSAP including an ESN assigned to the MSISDN.

11. The method of claim 10, wherein the fixed wireless terminal radio technology comprises at least one member of the group consisting of: GSM, 3G/UMTS; 4G/LTE and CDMA.

12. The method of claim 10, wherein the subscriber database query responds with a class of service indicator, with one indicator value for wireline and a second indicator value for wireless.

13. The method of claim 10, wherein the subscriber database query responds with at least two values, with at least one value for wireline and at least one different value for wireless.

14. The method of claim 10, wherein the subscriber database is coupled to an ALI and the ALI contains a list of fixed wireless subscribers.

15. The method of claim 10, wherein the subscriber database identifies a fixed wireless subscriber as within a range of MSISDNs, with the MSISDN range specified by a start number and an end number.

16. The method of claim 10, wherein the subscriber database identifies a fixed wireless subscriber using an MSISDN pattern.

17. The method of claim 10, wherein the Selective Router routing information is pre-configured based on data associated with an MSC.

18. The method of claim 10, wherein the Selective Router routing information is pre-configured based on data associated with the cell site.

19. A system for routing emergency services calls from a subscriber's fixed wireless terminal to a PSAP that serves the location of the subscriber and for delivering traditional landline ALI information associated with the subscriber to the PSAP; the system comprising: (a) data processing apparatus coupled with a GMLC; said data processing apparatus being operated such that:
(1) a subscriber database is queried using the subscriber's calling party identifier, wherein the calling party identifier comprises at least one member of the group consisting of: MSISDN, MDN, Calling Party Address and ANI;
(2) a response from the subscriber database query that indicates that the call is associated with a fixed wireless terminal;
(3) the subscriber's MSISDN is assigned as the calling party number; and
(4) Selective Router routing information is assigned based on configured data, wherein the routing information comprises at least one member of the group consisting of: trunk select digits and ESRN;
(c) a switch for routing the emergency services call to a Selective Router based on the routing information provided by the GMLC including the MSISDN as the calling party; and
(d) a Selective Router for delivering the emergency services call to the PSAP including an ESN assigned to the MSISDN.
